(19) United States
(12) Patent Application Publication
(10) Pub. No.: US 2009/0305073 A1
(43) Pub. Date: Dec. 10, 2009

(54) PLATINUM-FREE AND PALLADIUM-FREE CONDUCTIVE ADHESIVE AND ELECTRODE FORMED THEREBY

(75) Inventors: Wei-Hsing Tuan, Taipei City (TW); Shao-Ju Shih, Taipei City (TW); Shu- Ting Kuo, Taipei City (TW)

Correspondence Address: Muncy, Geissler, Olds & Lowe, PLLC, P.O. BOX 1364, FAIRFAX, VA, 22038-1364, US

(73) Assignee: NATIONAL TAIWAN UNIVERSITY

(21) Appl. No.: 12/204,405

(22) Filed: Sep. 4, 2008

(30) Foreign Application Priority Data
Jun. 9, 2008 (TW) 097121361

(51) Int. Cl. B32B 15/00; H01B 1/22

(52) U.S. Cl. 428/546; 252/514

(57) ABSTRACT

A platinum-free and palladium-free conductive adhesive includes silver particles, additive metal particles and a binder. Components of the additive metal particles are selected from the group consisting of tungsten, niobium, tantalum and molybdenum etc., and do not contain platinum and palladium. The binder adheres the silver particles and the additive metal particles together. A specific weight percentage of the additive metal particles in a mixture of the silver particles and the additive metal particles ranges from 1 to 70. The presence of the additive metal particles can suppress silver migration. An electrode formed by the conductive adhesive is also disclosed.

This application claims priority of No. 097121361 filed in Taiwan R.O.C. on Jun. 9, 2008 under 35 USC 119, the entire content of which is hereby incorporated by reference.

### BACKGROUND OF THE INVENTION

1. Field of Invention

The present invention relates in general to a platinum-free and palladium-free conductive adhesive and an electrode formed thereby, and more particularly to a conductive adhesive capable of suppressing silver migration and an electrode formed thereby.

2. Related Art

A silver paste is a mixed paste mainly formed by silver particles and an organic binder. Because the silver has the excellent electroconductivity, the silver paste is frequently used in electronic elements and modules by way of screen printing etc. At present, passive components (resistors, capacitors and inductors) and solar cell modules have silver electrodes formed by the silver paste serving as the original material. Because the silver has the excellent oxidation resistance, it can be co-fired or sintered with silicon, ceramic materials, glass, III-V group of elements in air and is thus widely used as an indispensable electrode material in the modern electronic elements and modules.

However, the silver electrode has an extremely serious drawback of silver migration, in which the silver electrode placing in the environment with moisture forms silver ions, and the silver ions are moved under the action of the electric field to cause the short-circuited phenomenon. This phenomenon disadvantageously influences the reliability in the electronic element and the electronic module containing the silver electrode, and has to be overcome.

The most-frequently adopted solution to solve the silver migration problem is adding noble metal, such as palladium (Pd) and platinum (Pt), to the silver electrode. This is because the noble metal and the silver can be mutually soluble during the high-temperature co-firing or sintering process so that the melting point of the silver alloy is increased, the silver ions cannot be easily released, and the silver migration may be suppressed. However, the noble metal has the extremely high price, and the silver electrode has the poor price competition ability. In addition, because the price of silver is getting higher and higher, it is advantageous for the application of silver electrodes if the non-noble metal may be added to replace a portion of silver and to decrease the silver migration.

Thus, it is a subject of the present invention to provide a low-cost conductive adhesive capable of suppressing the silver migration, and an electrode formed by the conductive adhesive.

### SUMMARY OF THE INVENTION

It is therefore an objective of the present invention to provide a low-cost conductive adhesive capable of suppressing silver migration and an electrode formed thereby.

The present invention achieves the above-identified objective by providing a platinum-free and palladium-free conductive adhesive, which includes a plurality of silver particles, a plurality of additive metal particles and a binder. Components of the additive metal particles are selected from the group consisting of tungsten, niobium, tantalum and molybdenum and do not contain platinum and palladium. The binder adheres the silver particles and the additive metal particles together. A specific weight percentage of the additive metal particles in a mixture of the silver particles and the additive metal particles ranges from 1 to 70 so as to suppress silver migration.

The present invention also provides an electrode including a plurality of silver particles and a plurality of additive metal particles. The additive metal particles are combined with the silver particles. Components of the additive metal particles are selected from the group consisting of tungsten, niobium, tantalum and molybdenum and do not contain platinum and palladium. A specific weight percentage of the additive metal particles in a mixture of the silver particles and the additive metal particles ranges from 1 to 70 so as to suppress silver migration.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the present art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic top view showing a water drop test.

FIG. 2 is a cross-sectional view taken along a line 2-2 of FIG. 1.

FIG. 3 is a comparison chart showing silver migration phenomena of several experimental examples of the present invention and the traditional example.

### DETAILED DESCRIPTION OF THE INVENTION

The present invention will be apparent from the following detailed description, which proceeds with reference to the accompanying drawings, wherein the same references relate to the same elements.

The spirit of the present invention is to add metal powder composed of non-noble metal, such as tungsten (W), niobium (Nb), tantalum (Ta) and/or molybdenum (Mo), to silver powder. The non-noble metal pertains to the transitional metal. More precisely speaking, the non-noble metal pertains to the IIIA and IVA transitional metals in the periodic table and has the excellent price competition ability.

In addition to the price competition ability, the following experimental evidence also shows that the silver migration problem can be suppressed by adding the non-noble metal powder to the silver powder.

The details of the present invention will be described according to several experimental examples. The test method is a water drop test, which is frequently adopted in testing the typical silver migration. The advantages of the present invention will be shown in the following, using the water drop test to compare the differences between the conductive adhesive of Ag powder in a first experimental example (also referred to as a reference group) with the conductive adhesives with the metal powder of the present invention in second to sixth experimental examples.

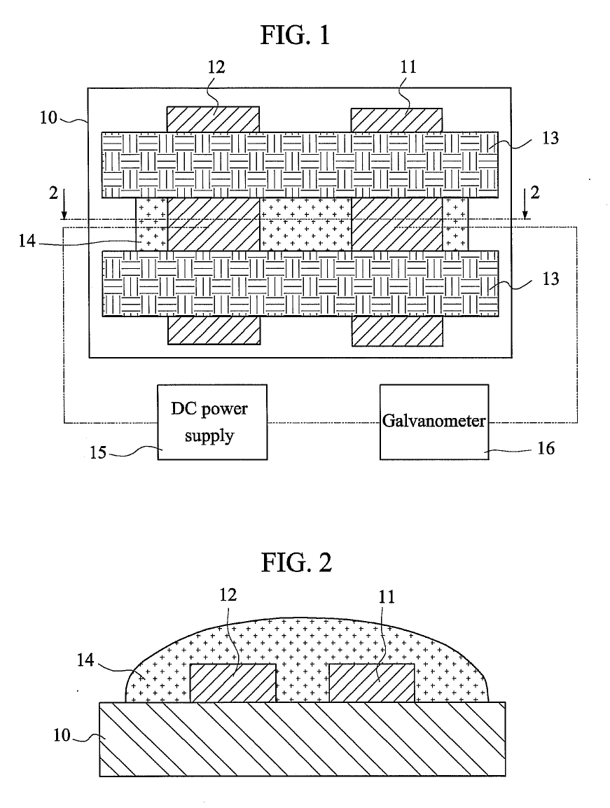

FIG. 1 is a schematic top view showing a water drop test. FIG. 2 is a cross-sectional view taken along a line 2-2 of FIG. 1. As shown in FIGS. 1 and 2, two lines of conductive adhesives 11 and 12 each having a width of 1.5 millimeters are printed on an aluminum oxide substrate 10 with a gap of 1 millimeter interposed therebetween in the water drop test. Then, the aluminum oxide substrate 10 is placed into an oven, and the two lines of conductive adhesives are fired into silver electrodes and fired onto the aluminum oxide substrate 10 at a suitable temperature. Then, the vaseline material 13 is applied to the aluminum oxide substrate 10 and the silver electrodes 11 and 12 to form a water-stop layer so that contact surface areas between the electrodes 11 and 12 and the deionized water 14 can be controlled. Next, the two lines of electrodes 11 and 12 are respectively connected to the positive and negative terminals of a DC power supply 15, and the voltage is adjusted to a suitable value, such as 4.07V. Then, a galvanometer 16, such as a volt-ohm-milliammeter, is provided to determine whether a stable voltage difference exists between the two electrodes. Then, 1 cc of deionized water 14 is dropped on the electrodes 11 and 12, and the timer is started. At the same time, the relationships between the variation of the current (2 mA to 15 mA) of the system and the variation of the structure between the electrodes 11 and 12 with respect to the time are observed.

### FIRST EXPERIMENTAL EXAMPLE (PURE SILVER CONDUCTIVE ADHESIVE, REFERENCE GROUP)

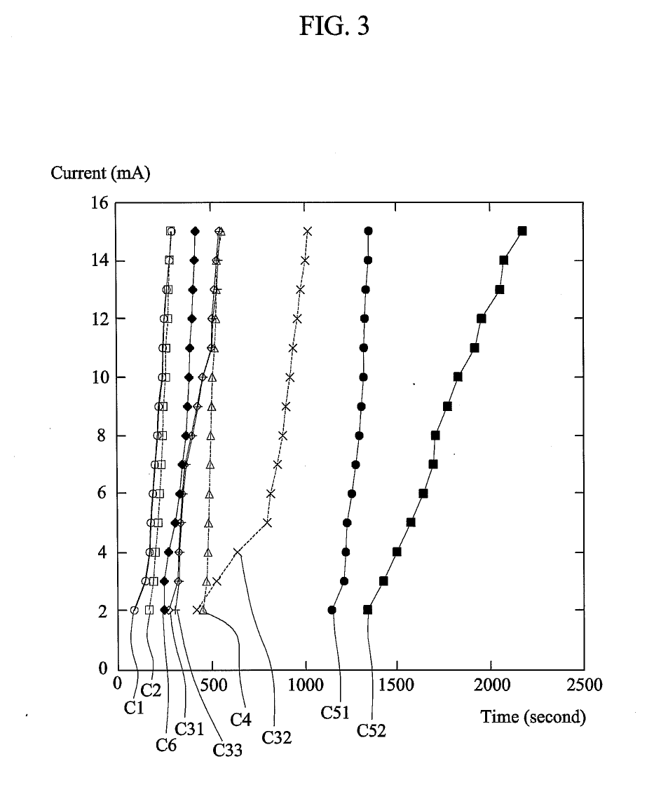

In this example, the pure silver powder and an organic binder are mixed by a three-roll mill for several minutes so that a silver conductive adhesive may be prepared. The binder may be composed of a single binding material or several binding materials. Then, the silver conductive adhesive is printed on the aluminum oxide substrate to form the silver electrodes according to the specification of FIG. 1. During the formation of the electrode, the temperature is increased to 850 degrees centigrade at the speed of 5 degrees per minute in the atmosphere of air, and the temperature is kept at 850 degrees centigrade for 30 minutes. Thereafter, the temperature is decreased to the room temperature at the speed of 5 degrees per minute. Then, the test for silver migration is performed and the result is obtained and represented by the curve C1 of FIG. 3. The result shows that the current has reached 15 mA (milliamperes) within 300 seconds. So, it is proved that the silver electrode made of the pure silver powder has the extremely serious problem of silver migration.

### SECOND EXPERIMENTAL EXAMPLE (SILVER-TUNGSTEN CONDUCTIVE ADHESIVE)

The silver powder is mixed with 10 weight percentage (10 wt %) of tungsten metal powder, and the Ag—W conductive adhesive is prepared according to the mixing method used in the first experimental example. Then, the conductive adhesive is printed on the aluminum oxide substrate to form the silver electrodes according to the specification of FIG. 1. During the formation of the electrode, the temperature is increased to 850 degrees centigrade at the speed of 5 degrees per minute in the atmosphere of nitrogen, and the temperature is kept at 850 degrees centigrade for 30 minutes. Thereafter, the temperature is decreased to the room temperature at the speed of 5 degrees per minute. Then, the test for silver migration is performed and the result is obtained and represented by the curve C2 of FIG. 3. Compared with the result of the first experimental example, it shows that the silver migration phenomenon of the silver tungsten electrodes cannot occur until a longer period of time has been elapsed. It is to be noted that the so-called weight percentage represents the percentage of ratio of the weight of the additive metal particles (W) to the weight of the mixture of the silver particle (Ag) and the additive metal particles (W). In this experimental example, the specific weight percentage is equal to 10 wt %.

### THIRD EXPERIMENTAL EXAMPLE (SILVER-NIOBIUM CONDUCTIVE ADHESIVE)

The silver powder is mixed with 5, 10 and 20 wt % of niobium metal powder, respectively, and the Ag—Nb conductive adhesives are prepared according to the mixing method used in the first experimental example. Then, the conductive adhesives are respectively printed on the aluminum oxide substrate to form the silver electrodes according to the specification of FIG. 1. During the formation of the electrode, the temperature is increased to 850 degrees centigrade at the speed of 5 degrees per minute in the atmosphere of air, and the temperature is kept at 850 degrees centigrade for 30 minutes. Thereafter, the temperature is decreased to the room temperature at the speed of 5 degrees per minute. Then, the tests for silver migration are performed and the results are obtained and represented by the curve C31 (5 wt % of niobium), C32 (10 wt % of niobium) and C33 (20 wt % of niobium) of FIG. 3. According to the result of the C32 curve, for example, the current cannot reach 15 mA until 1000 seconds have elapsed. Thus, it is proved that the silver migration problem can be improved in the silver electrode formed by the silver powder and the added niobium powder. In this experimental example, the specific weight percentage is equal to 5, 10 or 20 wt %.

### FOURTH EXPERIMENTAL EXAMPLE (SILVER-TANTALUM CONDUCTIVE ADHESIVE)

The silver powder is mixed with 10 wt % of tantalum metal powder, and the Ag—Ta conductive adhesive is prepared according to the mixing method used in the first experimental example. Then, the conductive adhesive is printed on the aluminum oxide substrate to form the silver electrodes according to the specification of FIG. 1. During the formation of the electrode, the temperature is increased to 850 degrees centigrade at the speed of 5 degrees per minute in the atmosphere of air, and the temperature is kept at 850 degrees centigrade for 30 minutes. Thereafter, the temperature is decreased to the room temperature at the speed of 5 degrees per minute. Then, the test for silver migration is performed and the result is obtained and represented by the curve C4 of FIG. 3. According to the result of the silver tantalum electrode, the current cannot reach 15 mA until 450 seconds have elapsed. Thus, it is proved that the silver migration problem can be improved in the silver electrode formed by the silver powder and the added tantalum powder. In this experimental example, the specific weight percentage is equal to 10 wt %.

### FIFTH EXPERIMENTAL EXAMPLE (SILVER-MOLYBDENUM CONDUCTIVE ADHESIVE)

The silver powder is mixed with 5 and 10 wt % of molybdenum metal powder, respectively, and the Ag—Mo conductive adhesives are prepared according to the mixing method used in the first experimental example. Then, the conductive adhesives are respectively printed on the aluminum oxide substrate to form the silver electrodes according to the specification of FIG. 1. During the formation of the electrode, the temperature is increased to 850 degrees centigrade at the speed of 5 degrees per minute in the atmosphere of air, and the temperature is kept at 850 degrees centigrade for 30 minutes. Thereafter, the temperature is decreased to the room temperature at the speed of 5 degrees per minute. Then, the tests for silver migration are performed and the results are obtained and represented by the curve C51 (5 wt % of molybdenum) and C52 (10 wt % of molybdenum) of FIG. 3. According to the result of the C52 curve, for example, the current cannot reach 15 mA until 2200 seconds have elapsed. Thus, it is proved that the silver migration problem can be improved in the silver electrode formed by the silver powder and the added molybdenum powder. In this experimental example, the specific weight percentage is equal to 5 or 10 wt %.

### SIXTH EXPERIMENTAL EXAMPLE (SILVER-TANTALUM-NIOBIUM CONDUCTIVE ADHESIVE)

The silver powder is mixed with 5 wt % of tantalum metal powder and 5 wt % of niobium metal powder, wherein the total weight percentage of tantalum and niobium is equal to 10 wt %, and the weight percentages of tantalum and niobium are the same, and the Ag—Ta—Nb conductive adhesive is prepared according to the mixing method used in the first experimental example. Then, the conductive adhesive is printed on the aluminum oxide substrate to form the silver electrodes according to the specification of FIG. 1. During the formation of the electrode, the temperature is increased to 850 degrees centigrade at the speed of 5 degrees per minute in the atmosphere of air, and the temperature is kept at 850 degrees centigrade for 30 minutes. Thereafter, the temperature is decreased to the room temperature at the speed of 5 degrees per minute. Then, the test for silver migration is performed and the result is obtained and represented by the curve C6 of FIG. 3. According to the result of the silver-tantalum-niobium electrode, the current cannot reach 15 mA until 420 seconds have elapsed. Thus, it is proved that the silver migration problem can be improved in the silver electrode formed by the silver powder, the added tantalum powder and the added niobium powder. In this experimental example, the specific weight percentage is equal to 10 wt %.

According to the above-mentioned experimental examples, it is found that the atomic numbers of W, Nb, Ta and Mo are respectively 74, 41, 73 and 42. In addition, Nb and Mo pertain to the fifth row of the periodic table, which includes the transitional metal elements having the atomic numbers ranging from 39 to 48 or includes the metal elements having the atomic numbers ranging from 39 to 52. Ta and W pertain to the sixth row of the periodic table, which includes the metal elements having the atomic numbers ranging from 57 to 84. Thus, it is concluded that any metal element having the atomic number greater than or equal to 39 may serve as the additive metals for the conductive adhesive. Preferably, the metal elements having the atomic numbers ranging from 39 to 52, or the metal elements having the atomic numbers ranging from 57 to 84 may be selected.

On the other hand, the specific weight percentage of platinum or palladium usually has to be greater than or equal to 1 so that the suitable property can be provided according to the conventional data. Thus, the property of the present invention can be achieved as long as the specific weight percentage of the additive metal particles is greater than or equal to 1. Of course, the additive metal particles do not contain the silver, and do not contain the platinum and palladium according to the consideration of the price. Furthermore, the upper bound of the specific weight percentage of the additive metal particles is about 70 to prevent the electroconductive property from being damaged.

Therefore, the present invention provides a platinum-free and palladium-free conductive adhesive including a plurality of silver particles, a plurality of additive metal particles and a binder. The components of the additive metal particles are selected from the group consisting of several metal elements. An atomic number of each of the metal elements is greater than or equal to 39, and the metal elements do not contain platinum and palladium. The binder may be an organic binder for adhering the silver particles and the additive metal particles together. The specific weight percentage of the additive metal particles in the mixture of the silver particles and the additive metal particles ranges from 1 to 70 so as to suppress the silver migration. More particularly, the specific weight percentage ranges from 2 to 60, preferably ranges from 3 to 50, preferably ranges from 4 to 40, preferably ranges from 5 to 30, preferably ranges from 5 to 25 or more preferably ranges from 5 to 20.

In addition, the conductive adhesive may further include a plurality of glass particles, wherein the binder adheres the silver particles, the additive metal particles and the glass particles together. The glass particles can advantageously enhance the binding strength between the co-fired or sintered electrode and the substrate.

Each of the above-mentioned conductive adhesives may be printed on the substrate and then co-fired or sintered in the environment of air or nitrogen. Because the binder is finally volatilized, the co-fired or sintered electrode does not contain the binder, and only the combination of silver particles and additive metal particles is left. Thus, the present invention also provides an electrode, which includes a plurality of silver particles and a plurality of additive metal particles. The additive metal particles and the silver particles are combined together. The components of the additive metal particles are selected from several metal elements. Each metal element has an atomic number greater than or equal to 39. The metal elements do not contain platinum and palladium. The specific weight percentage of the additive metal particles in the mixture of the silver particles and the additive metal particles ranges from 1 to 70 so as to suppress the silver migration.

The additive metal particles are particularly selected from the group consisting of tungsten, niobium, tantalum and molybdenum, and the specific weight percentage particularly ranges from 5 to 20.

Similarly, the conductive adhesive may further include a plurality of glass particles, wherein the glass particles can combine the silver particles, the additive metal particles and the substrate, on which the conductive adhesive is applied, together in the high-temperature co-firing or sintering process. Thus, the silver particles, the additive metal particles and the glass particles may be combined together in the electrode of the present invention.

According to the description of the present invention, a low-cost conductive adhesive can be provided, and the silver migration problem in the electrode formed by the conductive adhesive can be suppressed.

While the present invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A platinum-free and palladium-free conductive adhesive, comprising:
a plurality of silver particles;
a plurality of additive metal particles, wherein components of the additive metal particles are selected from the group consisting of metal elements having atomic numbers greater than or equal to 39, and do not contain platinum and palladium; and
a binder, which adheres the silver particles and the additive metal particles together, wherein a specific weight percentage of the additive metal particles in a mixture of the silver particles and the additive metal particles ranges from 1 to 70 so as to suppress silver migration.

2. The conductive adhesive according to claim 1, wherein the components of the additive metal particles are selected from the group consisting of tungsten, niobium, tantalum and molybdenum.

3. The conductive adhesive according to claim 2, wherein the specific weight percentage ranges from 5 to 20.

4. The conductive adhesive according to claim 3, wherein the components of the additive metal particles are tungsten particles, and the specific weight percentage is substantially equal to 10.

5. The conductive adhesive according to claim 3, wherein the components of the additive metal particles are niobium particles, and the specific weight percentage is substantially equal to 5, 10 or 20.

6. The conductive adhesive according to claim 3, wherein the components of the additive metal particles are tantalum particles, and the specific weight percentage is substantially equal to 10.

7. The conductive adhesive according to claim 3, wherein the components of the additive metal particles are molybdenum particles, and the specific weight percentage is substantially equal to 5 or 10.

8. The conductive adhesive according to claim 3, wherein the components of the additive metal particles are tantalum and niobium particles, and the specific weight percentage is substantially equal to 10.

9. The conductive adhesive according to claim 8, wherein a weight percentage of the additive metal particles of tantalum is substantially the same as a weight percentage of the additive metal particles of niobium.

10. The conductive adhesive according to claim 1, further comprising:
a plurality of glass particles, wherein the binder adheres the silver particles, the additive metal particles and the glass particles together.

11. An electrode, comprising:
a plurality of silver particles; and
a plurality of additive metal particles combined with the silver particles, wherein components of the additive metal particles are selected from the group consisting of metal elements having atomic numbers greater than or equal to 39, and do not contain platinum and palladium, and a specific weight percentage of the additive metal particles in a mixture of the silver particles and the additive metal particles ranges from 1 to 70 so as to suppress silver migration.

12. The conductive adhesive according to claim 11, wherein the components of the additive metal particles are selected from the group consisting of tungsten, niobium, tantalum and molybdenum.

13. The electrode according to claim 12, wherein the specific weight percentage ranges from 5 to 20.

14. The electrode according to claim 13, wherein the components of the additive metal particles are tungsten particles, and the specific weight percentage is substantially equal to 10.

15. The electrode according to claim 13, wherein the components of the additive metal particles are niobium particles, and the specific weight percentage is substantially equal to 5, 10 or 20.

16. The electrode according to claim 13, wherein the components of the additive metal particles are tantalum particles, and the specific weight percentage is substantially equal to 10.

17. The electrode according to claim 13, wherein the components of the additive metal particles are molybdenum particles, and the specific weight percentage is substantially equal to 5 or 10.

18. The electrode according to claim 13, wherein the components of the additive metal particles are tantalum and niobium particles, and the specific weight percentage is substantially equal to 10.

19. The electrode according to claim 18, wherein a weight percentage of the additive metal particles of tantalum is substantially the same as a weight percentage of the additive metal particles of niobium.

20. The electrode according to claim 13, further comprising:
a plurality of glass particles, wherein the silver particles, the additive metal particles and the glass particles are combined together.
